(19) United States
(12) Patent Application Publication
(10) Pub. No.: US 2003/0070506 A1
(43) Pub. Date: Apr. 17, 2003

(54) Crank structure for bicycle

(75) Inventors: Rock Tseng, Hsinchu (TW); Roger Hu, PinChen City (TW); Dan Chuang, TaoYuan Hsien (TW)

Correspondence Address: DOUGHERTY & TROXELL, SUITE 1404, 5205 LEESBURG PIKE, FALLS CHURCH, VA, 22041, US

(73) Assignee: Apex Bicycle Components Corporation Ltd.

(21) Appl. No.: 09/976,013

(22) Filed: Oct. 15, 2001

(51) Int. Cl. G05G 1/14

(52) U.S. Cl. 74/594.1

(57) ABSTRACT

An improved crank structure for bicycle, wherein, a gear plate connector and a pedal connector are installed on two ends of a crank, and there are a first side and a second side extended between the gear plate connector and the pedal connector; there are two pairs of thickness and width perpendicularly and crosswise installed on each of the first side and the second side, and the thicknesses and widths can be measured; the feature is the crank is a non-symmetrical structure. Further, at least one cavity is positioned between the first side and the second side of crank for loosing weight and decreasing cost.

### 1. FIELD OF THE INVENTION

The present invention relates to an improved crank structure for bicycle, especially a pedal crank suitable for bicycle, and the crank body is a non-symmetrical structure.

### 2. BACKGROUND OF THE INVENTION

The present technology is developed to well and well, and the traffic is more convenient, thus cars, motorcycles, and even public transportation systems are utilized more often. Hence, traffic jam is the following big problem. Riding bicycles to offices is a trend at this moment; therefore an issue for lightening bicycle to easily ride is a focus. On the other hand, racing bicycle to be lightened is more important to be discussed.

Referring to FIG. 1A, which is a top view of bicycle crank of prior art, an end of the crank is a gear plate connector 1, and the other symmetrical end is a pedal connector 2. As showing in FIG. 1C, this is a symmetrical structure because a side thickness d1 is equal to a side thickness d2.

Referring to FIG. 2A, which a sectional view of bicycle crank of prior art, between two sides is a cavity 3, and a side thickness d1′ is same as a side thickness d2′ on the other side, further, a side width w1′ and a side width w2′ on the other side are equal to each other. FIG. 2B shows another direction section view of bicycle crank of prior art, there are two cavities 4 symmetrically designed on the two sides, and a side thickness d1″ is equal to another side thickness d2″ on the other side, a side width w1″ is equal to another side width w2″. As showing in FIG. 2, it is a symmetrical structure. For general metal material, tensile strength is normally smaller than compressive strength. Obviously, the crank in prior art is symmetrical, and it makes three conditions, which are material waste, heavier weight and higher cost.

### SUMMARY OF THE INVENTION

The main object of the present invention relates to an improved crank structure for bicycle. After improvement, the bicycle crank is non-symmetrical structure to loose weight and save cost.

The second object of the present invention is to offer an improved crank for bicycle for suiting different materials, and it is to easily form and manufacture the improved structure.

To reach above objects, an improved bicycle crank is then designed, wherein, two ends of the crank are a gear plate connector and a pedal connector, further there are a first side and a second side extended between the gear plate connector and a pedal connector. There are two pairs of thickness and width perpendicularly and crosswise installed on each of the first side and the second side, and the thicknesses and widths can be measured. The feature for the crank is non-symmetrical. Between the first side and the second side is further composed a cavity for loosing weight and saving cost. The crank is manufactured by forging or CNC machining.

For further understanding the present invention, please refer to the following drawings, description.

### BRIEF DESCRIPTION OF THE DRAWINGS

FIG. 1A is a top view of bicycle crank of prior art.

FIG. 1B is a side view of bicycle crank of prior art.

FIG. 1C is A-A section view of bicycle crank of prior art.

FIG. 2A is another section view of bicycle crank of prior art.

FIG. 2B is the third section view of bicycle crank of prior art.

FIG. 3 is the preferred embodiment of application of the present invention.

FIG. 4A is the preferred embodiment of the top view of the present invention.

FIG. 4B is the preferred embodiment of the side view of the present invention.

FIG. 4C is the preferred embodiment of B-B section view of the present invention.

FIG. 5 series are other preferred embodiments of section view of the present invention.

FIG. 6 is another preferred embodiment of the present invention.

FIG. 7 is another preferred embodiment of the top view of the present invention.

FIG. 8 is another preferred embodiment of the top view of the present invention.

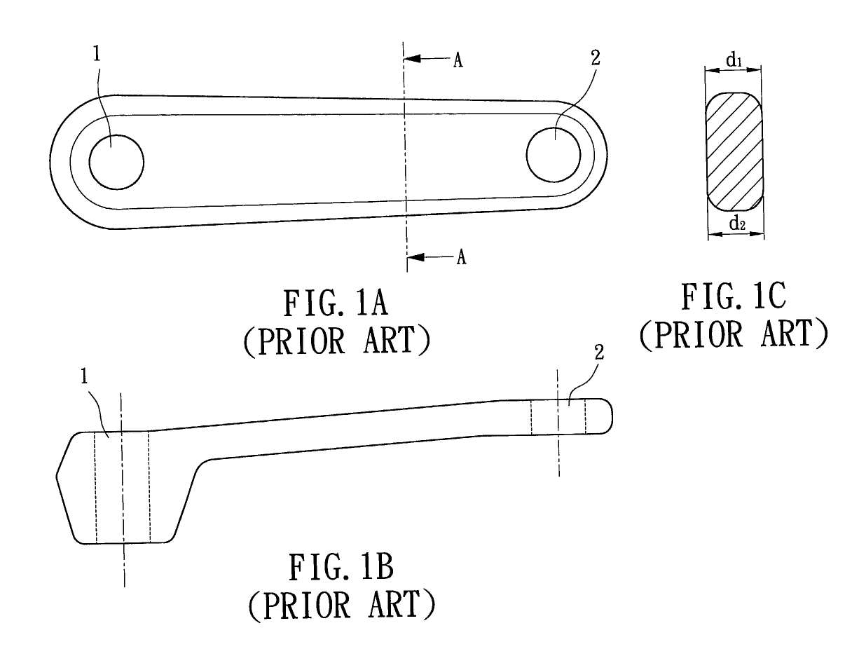

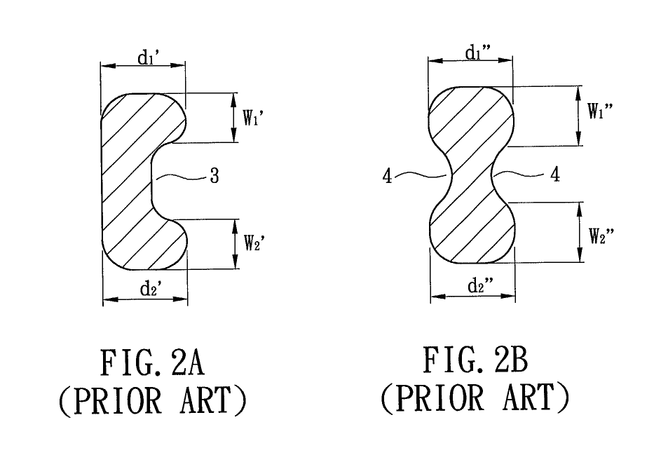

### DETAILED DESCRIPTION OF THE PREFERRED EMBODIMENT

The present invention is to offer an improved crank structure for bicycle, and the structure is a non-symmetrical structure, which can be manufactured with whole body. The utilized material is less and the strength is not lower either, but the weight is lighter. The cost is lower, and furthermore it is suitable for different materials.

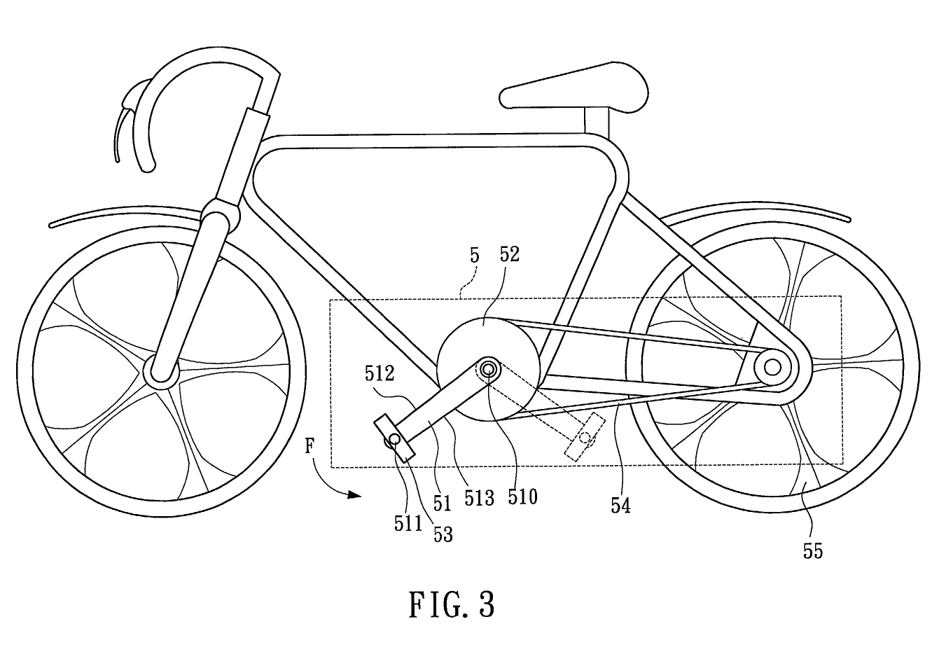

FIG. 3 is the preferred embodiment of application of the present invention, wherein a transmission system 5 consists of a crank 51, which two ends are separately designed a gear plate connector 510 and a pedal connector 511 and a first side 512, a second side 513 extended between the gear plate connector 510 and the pedal connector 511; a gear plate 52, connects to gear plate connector 510; a pedal 53, connects to pedal connector 315; a driving chain 54, connects to the gear plate 52 and a wheel 55. Stepping on the pedal 53 to drive gear plate 52 via rotating the crank 51, thus the driving chain 54 is also driven to rotate wheel 55. As showing in FIG. 3, when moving toward F direction, the first side 512 of crank 51 is applied by tensile stress, and the second side 513 is applied by compressive stress. For general metal material, tensile strength is normally smaller than compressive strength, therefore, a crank of a non-symmetrical structure is designed based on the point. The crank 51 which compressive strength is greater than tensile strength, meantime because the first side 512 is applied by tensile stress, the first side 512 is then designed as thicker relative to the other side for resisting force; the second side 513 is applied by compressive stress, thus the thickness of the second side 513 is thinner relative to the first side 512, and the crank is a non-symmetrical structure. On the other hand, if tensile strength is greater than compressive strength, for example, some complex material, and the concept shall be from opposite direction.

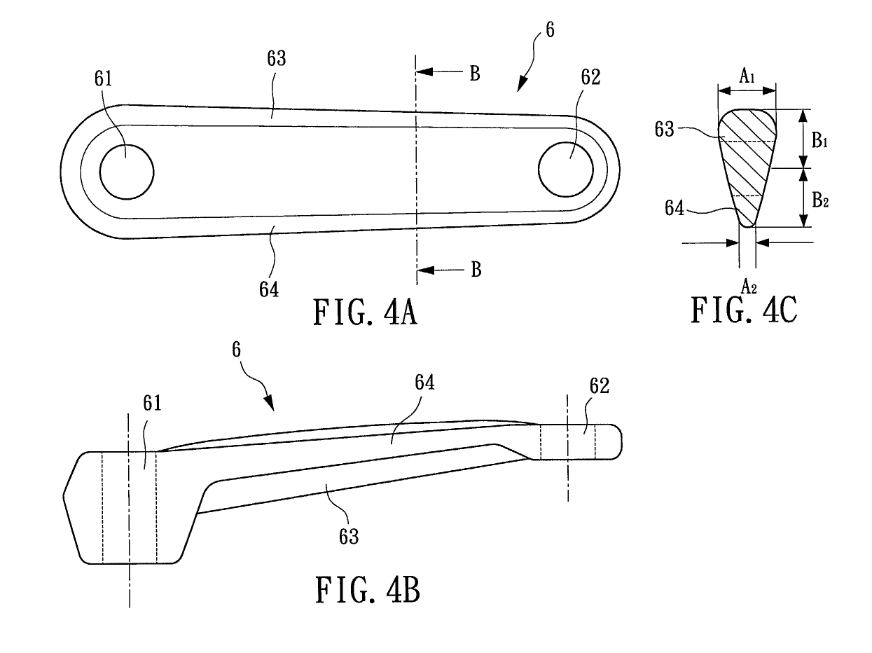

FIG. 4A is the preferred embodiment of the top view of the present invention. FIG. 4B is the preferred embodiment of the side view of the present invention. Wherein, a crank 6 is with a gear plate connector 61 and a pedal connector 62 on its two ends. A first side 63 and a second side 64 extend between the gear plate connector 61 and the pedal connector 62. FIG. 4C is the preferred embodiment of B-B section view of the present invention, wherein the first side 63 is with a thickness A1 and width B1 which are perpendicular to each other, and the second side 64 is with a

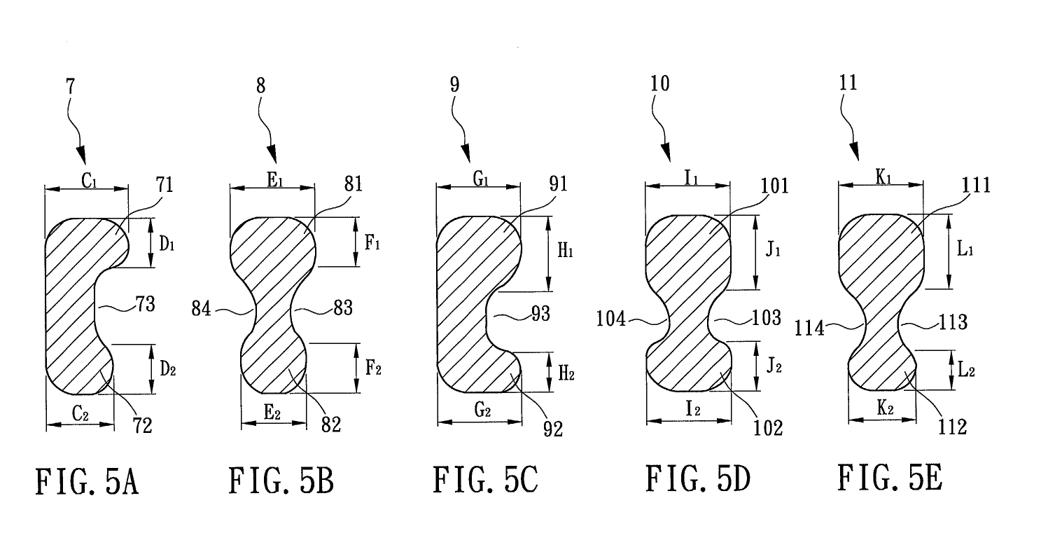

FIG. 5D is another preferred embodiment of the present invention, wherein there is a cavity 103 designed between a first side 101 and a second side 102 for crank 10 to reduce weight, and there is another cavity 104 on the side relative to the side with the cavity 103. A thickness I1 is equal to a thickness I2, and a width J1 is greater than a width J2, therefore, this is a non-symmetrical structure.

FIG. 5E is another preferred embodiment of the present invention, wherein there is a cavity 113 designed between a first side 111 and a second side 112 for crank 11 to reduce weight, and there is another cavity 114 on the side relative to the side with the cavity 113. A thickness K1 is greater than a thickness K2, and a width L1 is greater than a width L2, therefore, this is a non-symmetrical structure.

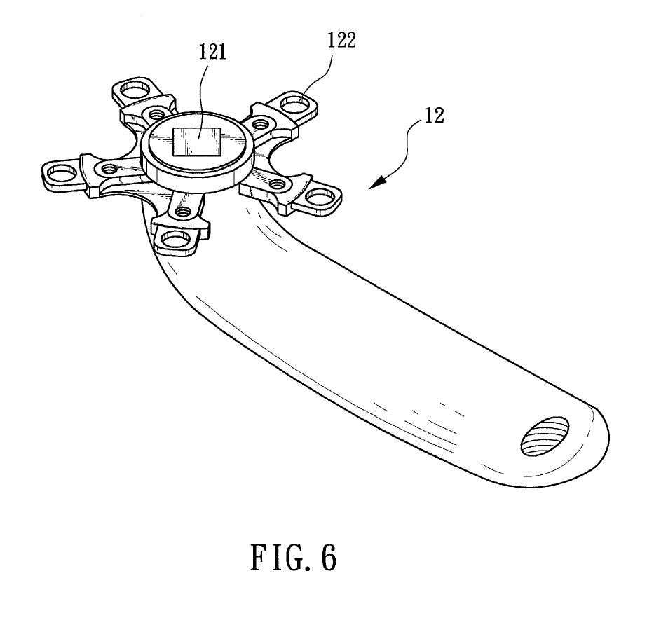

FIG. 6 is another preferred embodiment of the present invention, wherein, five gear plate fasteners 122 are designed on the outer rim of gear plate connector 121 of crank 12 to enhance the combining strength of gear plate connector 121 and gear plate.

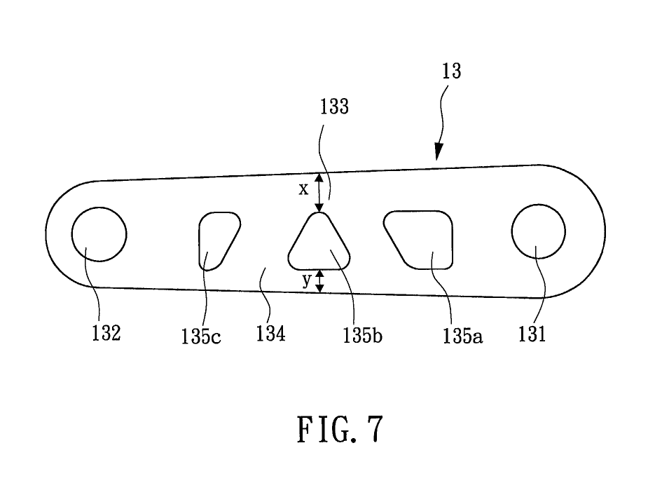

FIG. 7 is another preferred embodiment of the top view of the present invention. There are a gear plate connector 131 and a pedal connector 132 installed on two ends of crank 13, and a first side 133 and a second side 134 extended between the first gear plate connector 131 and the pedal connector 132. The two sides of crank 13 are designed three holes of 135a, 135b and 135c. The x distance of the first side 133 is greater than the y distance of the second side 134 on FIG. 7, therefore, this is a non-symmetrical structure.

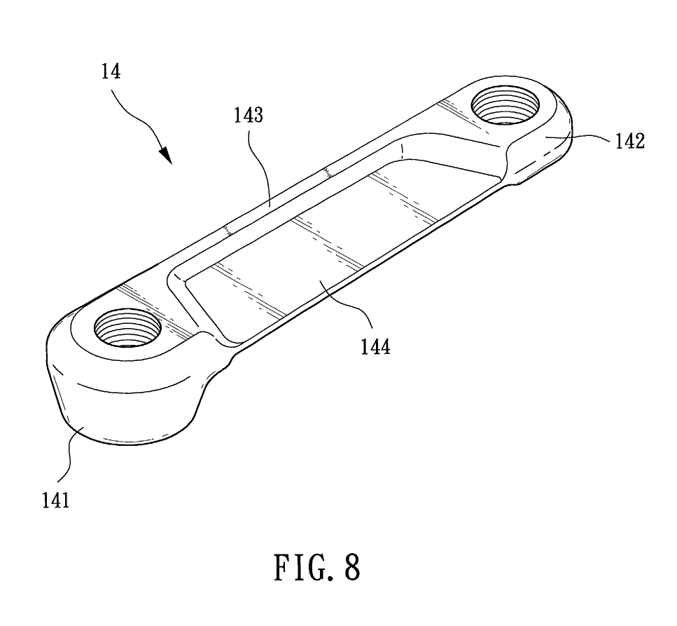

FIG. 8 is another preferred embodiment of the present invention. A gear plate connector 141 and a pedal connector 142 are installed on two ends of crank 14, and two thicknesses of the two connectors are equal. There is an inclined and stripe plane between an edge of the first side 143 and an edge of the second side 144 for easily taking apart and assembling. The thickness of first side 143 is greater than the thickness of second side 144. The inclined and stripe plane between first side 143 and second side 144 is to avoid the condition of stress concentration. Thus, obviously, this is also a non-symmetrical structure. First side 143 is applied by tensile stress and second side 144 is applied by compressive stress during operating bicycle. For general metal material, tensile strength is smaller than compressive strength, the non-symmetrical structure is based on the theory.

The present invention is a non-symmetrical structure of crank. In cases of that the thickness of first side is greater than the thickness of second side, and the width of first side is equal to the width of second side; the thickness of first side is equal to the thickness of second side, and the width of first side is greater than the width of second side; the thickness of first side is greater than the thickness of second side, and the width of first side is greater than the width of second side, all mentioned cases are not short on strength, furthermore, weight is lost, bicycle speed is promoted and cost is down. On the other hand, there are many materials which can be applied on the product, and the product can be manufactured with whole body.

The above descriptions are the preferable embodiments of the present invention. The covered scopes of the present invention are not restricted on the embodiments shown in the present invention. All the changes according to the contents of the present invention, such as: the change of shapes or locations of the arrangement of the fastening structures, etc., the generated functions and characteristics similar to those of the embodiments of the present invention and any ideas thought by the persons well-known such technologies are all within the scopes of the present invention.

What is claimed is:

1. An improved crank structure for bicycle, wherein a gear plate connector and a pedal connector are installed on two ends of a crank, and there are a first side and a second side extended between the gear plate connector and the pedal connector; there are two pairs of thickness and width perpendicularly and crosswise installed on each of the first side and the second side, and the thicknesses and widths can be measured; the feature is the crank is a non-symmetrical structure, and the thickness of the first side is greater than the thickness of the second side.

2. The improved crank structure for bicycle as cited in claim 1, wherein, the crank includes a cavity positioned between the first side and the second side.

3. The improved crank structure for bicycle as cited in claim 2, wherein, another cavity is installed on the other side relative to the said cavity.

4. The improved crank structure for bicycle as cited in claim 1, wherein, the crank includes plural holes positioned between the two sides of the crank.

5. The improved crank structure for bicycle as cited in claim 1, wherein, plural gear plate fasteners are designed on the outer rim of gear plate connector of crank to enhance the combining strength of gear plate connector and a gear plate.

6. An improved crank structure for bicycle, wherein a gear plate connector and a pedal connector are installed on two ends of a crank, and there are a first side and a second side extended between the gear plate connector and the pedal connector; there are two pairs of thickness and width perpendicularly and crosswise installed on each of the first side and the second side, and the thicknesses and widths can be measured; the feature is the crank is a non-symmetrical structure, and the width of the first side is greater than the width of the second side.

7. The improved crank structure for bicycle as cited in claim 6, wherein, the crank includes a cavity positioned between the first side and the second side.

8. The improved crank structure for bicycle as cited in claim 7, wherein, another cavity is installed on the other side relative to the said cavity.

9. The improved crank structure for bicycle as cited in claim 6, wherein, the crank includes plural holes positioned between the two sides of the crank.

10. The improved crank structure for bicycle as cited in claim 6, wherein, plural gear plate fasteners are designed on the outer rim of gear plate connector of crank to enhance the combining strength of gear plate connector and a gear plate.

11. An improved crank structure for bicycle, wherein a gear plate connector and a pedal connector are installed on two ends of a crank, and there are a first side and a second side extended between the gear plate connector and the pedal connector; there are two pairs of thickness and width perpendicularly and crosswise installed on each of the first side and the second side, and the thicknesses and widths can be measured; the feature is the crank is a non-symmetrical structure, the thickness of the first side is greater than the thickness of the second side, and the width of the first side is greater than the width of the second side.

12. The improved crank structure for bicycle as cited in claim 11, wherein, the crank includes a cavity positioned between the first side and the second side.

13. The improved crank structure for bicycle as cited in claim 12, wherein, another cavity is installed on the other side relative to the said cavity.

14. The improved crank structure for bicycle as cited in claim 11, wherein, the crank includes plural holes positioned between the two sides of the crank.

15. The improved crank structure for bicycle as cited in claim 11, wherein, plural gear plate fasteners are designed on the outer rim of gear plate connector of crank to enhance the combining strength of gear plate connector and a gear plate.
